(19) United States
(12) Patent Application Publication
(10) Pub. No.: US 2013/0087002 A1
(43) Pub. Date: Apr. 11, 2013

(54) Internal Gear Machine

(71) Applicant: Robert Bosch GmbH, Stuttgart (DE)

(72) Inventors: Marc Laetzel, Stuttgart (DE); Klaus Griese, Kupferzell (DE)

(73) Assignee: Robert Bosch GmbH, Stuttgart (DE)

(21) Appl. No.: 13/645,219

(22) Filed: Oct. 4, 2012

(30) Foreign Application Priority Data
Oct. 6, 2011 (DE) 10 2011 115 010.6

(51) Int. Cl. F16H 1/10

(52) U.S. Cl. 74/412 R

(57) ABSTRACT

An internal gear machine has a pinion which meshes with an internal gearwheel. The meshing of the pinion and of the internal gearwheel is configured such that it has an essentially closed engagement line.

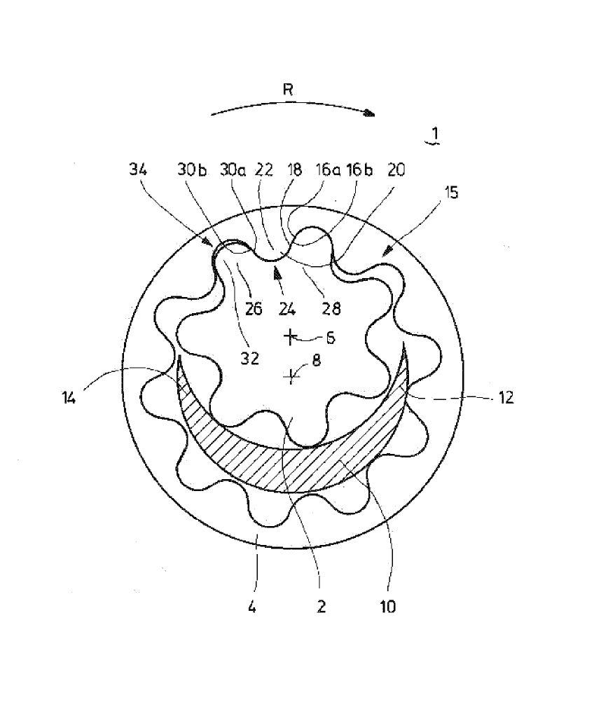

This application claims priority under 35 U.S.C. §119 to patent application no. DE 10 2011 115 010.6, filed on Oct. 6, 2011 in Germany, the disclosure of which is incorporated herein by reference in its entirety.

### BACKGROUND

The disclosure relates to an internal gear machine. In particular, the disclosure relates to a hydraulic internal gear machine, that is to say a hydraulic internal gear pump or a hydraulic internal gear motor.

The publication Transaction of the ASME, 736/Vol. 105, December 1983, entitled “A New Continuous Contact Low-Noise Gear Pump”, by K. Mitome and K. Seki discloses an external gear pump. This has two gearwheels which mesh with one another via a toothing. An engagement point of the toothing moves continuously, during a rotational movement of the gearwheels, along a closed engagement line which is in the form of an “8”.

The disadvantage of this is that, in the case of newly produced external gear pumps, a time-consuming running-in operation has to be carried out before they can be fully loaded. Moreover, the service life of external gear pumps of this type is comparatively short.

By contrast, internal gear pumps usually have a longer service life and a running-in operation is unnecessary. The publication DE 37 37 961 A1 illustrates an internal gear pump of this type. This has a driving gearwheel which is arranged inside a ring wheel and meshes with the latter. Axes of rotation of the gearwheel and of the ring wheel are arranged at a parallel distance from one another. The toothing of the gearwheel and of the ring wheel is in this case configured in such a way that teeth of the toothing do not touch a tip region and a root region. An engagement line, along which engagement points of the toothing move during a rotational movement of the gearwheel and of the ring wheel, is in this case not closed, thus giving rise, during a rotational movement, to an engagement jump. Moreover, a space arises between the teeth which is closed off from a suction side and from a delivery side of the internal gear pump and is filled with a conveying medium, this space being a squeezed-oil space. When the squeezed-oil space is opened to the low-pressure side, the disadvantage is that high flow and operating noises occur.

A further embodiment of an internal gear pump is disclosed in DE 43 38 874 C2. In this case, an involute toothing is provided between a ring wheel and a gearwheel meshing therein. A filler piece is arranged in a sickle-shaped free space between the gearwheel and the ring wheel. An engagement line in the involute toothing is of open form. The disadvantage here too is that, because of the involute toothing, a conveying medium is not displaced completely out of the tooth chamber volume, thus leading to the formation of squeezed oil and to high pressure pulsations.

By contrast, the object on which the disclosure is based is to provide an internal gear machine which has comparatively low noises during operation.

This object is achieved by an internal gear machine having the features described below.

### SUMMARY

According to the disclosure, an internal gear machine, in particular an internal gear pump, has a pinion which meshes with an internal gearwheel inside the latter. Axes of rotation of the pinion and of the internal gearwheel are in this case arranged at a parallel distance from one another. Advantageously, a toothing of the pinion and of the internal gearwheel has an engagement line, along which engagement points of the toothing move during a rotational movement of the pinion and of the internal gearwheel and which is essentially closed.

This solution has the advantage that there is no abrupt change in the engagement points, as in the internal gear machines explained above. Instead, the engagement points move along a closed engagement line. On account of this, no squeezed-oil spaces occur between teeth of the toothing, thus leading to a reduction of flow and operating noises and to reduced pressure pulsation.

In a further embodiment, the engagement line has essentially the form of an “8”. As a result, the engagement points move along a curved path which has no kinks. This leads, in turn, to an extremely uniform movement of the engagement points.

For further noise reduction, the toothing of the pinion and of the internal gearwheel is a helical toothing.

A sickle-shaped filler piece is preferably arranged between the pinion and the internal gearwheel.

Advantageously, the internal gear machine has an axial-force compensation device so that axial forces acting upon the pinion and the internal gearwheel are compensated on the end faces of these. The axial-force compensation device is, for example, hydrostatic pressure fields which are formed on the end faces of the pinion and of the gearwheel or are mechanical compensators which are arranged on the end faces.

The toothing of the pinion and of the internal gearwheel preferably has in each case an essentially wavy cross section.

Other advantageous developments are described below.

### BRIEF DESCRIPTION OF THE DRAWINGS

The disclosure is explained in more detail below by means of a diagrammatic drawing. This shows a simplified illustration of a cross-sectional view of an internal gear machine according to an exemplary embodiment.

### DETAILED DESCRIPTION

The single FIGURE illustrates a cross-sectional view of an internal gear machine 1 in a greatly simplified illustration. This has a pinion 2 which is arranged inside an internal gearwheel 4 and which meshes with the latter. The axis of rotation 6 of the pinion 2 and the axis of rotation 8 of the internal gearwheel 4 are arranged at a parallel distance from one another. An outer circle of the pinion 2 and the inner circle of the internal gearwheel 4 delimit a sickle-shaped area. A filler piece 10 is arranged between the internal gearwheel 4 and the pinion 2 and has a cross section which corresponds approximately to the sickle-shaped area.

Internal gear machines 1 of this type may be internal gear pumps or internal gear motors. If the internal gear machine 1 is used as an internal gear pump, the pinion 2 is connected to an engine. A low-pressure connection is formed on the end faces of the pinion 2 and of the internal gearwheel 4 approximately in the region of the end portion 12 of the filler piece 10 on the right in the FIGURE and a high-pressure connection of the internal gear machine 1 is formed on the end face in the region of a left end portion 14 of the filler piece 10. During a rotational movement of the internal gear machine 1 clockwise (direction of the arrow R), a conveying medium is conveyed from the low-pressure connection in the direction of the high-pressure connection as a result of the enlargement of a volume between toothed flanks of a toothing 15 of the pinion 2 and of the internal gearwheel 4. In the region of the high-pressure connection, the volume between the two flanks decreases again, with the result that a conveying medium is displaced.

In the FIGURE, the pinion 2 bears with its gearwheel rear flanks 16a against the corresponding gearwheel rear flanks 16b of the driven internal gearwheel 4. Instantaneous engagement points of the pinion 2 with the internal gearwheel 4 are identified by the reference symbol 18. These engagement points 18 move along a closed engagement line in the course of a gearwheel revolution. The engagement line is in this case in the form of an “8”. During the gearwheel revolution, the engagement points travel from gearwheel rear flanks 16a and 16b to a tip region 20 of a tooth 22 of the internal gearwheel 4 and to a root region 24 between two teeth 26 and 28 of the pinion 2. Gearwheel front flanks 30a and 30b of the pinion 2 and of the internal gearwheel 4 then come into engagement, with the result that the engagement points 18 are then located in this region. In the further course of the gearwheel revolution, after the gearwheel rear flanks 30a and 30b, the tip region 32 of the tooth 26 of the pinion 2 comes into contact with the root region 34 of the internal gearwheel 4. The engagement points 18 are subsequently located between the gearwheel rear flanks 16a and b again. Since the pinion 2 and the internal gearwheel 4 have engagement points not only in the region of their gearwheel front and rear flanks 16, 30, as in an involute toothing in the prior art explained in the introduction, but also in their tip region and root region 20, 24; 32, 34, the engagement points 18 pass through a closed engagement line in the form of an “8” during a gearwheel revolution. There is therefore no jumpy change of the engagement points 18 between successive gearwheel front and rear flanks 16, 30. As a result of a toothing 15 of this type, no squeezed spaces are formed between the teeth, and because of this pressure pulsation is extremely low. Essentially complete displacement of conveying medium between the teeth is thus achieved.

Toothing 15 is a helical toothing. The axial forces thereby occurring are compensated by an axial-force compensation device. In this case, hydrostatic pressure fields are provided on the end faces of the pinion 2 and of the internal gearwheel 4. Alternatively, mechanical actuators are arranged on the end faces.

On account of manufacturing tolerances of the pinion 2 and of the internal gearwheel 4, it is conceivable that the engagement points 18 deviate from an ideal engagement line in the form of an 8 and that this has minor discontinuities and/or kinks along it.

An internal gear machine with a pinion which meshes with an internal gearwheel is disclosed. The toothing of the pinion and of the internal gearwheel is in this case configured in such a way that it has an essentially closed engagement line.

What is claimed is:

1. An internal gear machine comprising:
a pinion having a pinion axis of rotation; and
an internal gearwheel having a gearwheel axis of rotation, the internal gearwheel configured to toothably engage the pinion, wherein:
the pinion axis of rotation and the gearwheel axis of rotation are offset with respect to one another; and
the pinion and the internal gearwheel are configured such that a toothed engagement of the pinion with the internal gearwheel has an essentially closed engagement line.

2. The internal gear machine of claim 1, wherein the engagement line, along which engagement points of the toothed engagement move during a rotational movement of the pinion and of the internal gearwheel, is shaped essentially as a figure eight.

3. The internal gear machine of claim 1, wherein the toothed engagement is a helical engagement.

4. The internal gear machine of claim 1, further comprising a sickle-shaped filler piece arranged between the pinion and the internal gearwheel.

5. The internal gear machine of claim 1, further comprising end faces configured to absorb forces acting in an axial direction upon the pinion and the internal gearwheel with an axial-force compensation device.

6. The internal gear machine of claim 5, wherein the axial-force compensation device is formed from at least one of hydrostatic pressure fields and mechanical compensators.

7. The internal gear machine of claim 1, wherein the toothed engagement of the pinion and the internal gearwheel has an essentially wavy cross section.
